(19) United States
(12) Patent Application Publication
(10) Pub. No.: US 2010/0119985 A1
(43) Pub. Date: May 13, 2010

(54) CURING OVEN

(75) Inventors: Michael Potterill, St. Helens (GB); Georg Oster, Telgte (DE)

Correspondence Address: BARNES & THORNBURG LLP, 11 SOUTH MERIDIAN, INDIANAPOLIS, IN, 46204, US

(73) Assignee: Bernd Munstermann GmbH & Co. KG.

(21) Appl. No.: 12/593,640

(22) PCT Filed: Mar. 29, 2008
(86) PCT No.: PCT/EP08/53776

§ 371 Date: Dec. 9, 2009

(30) Foreign Application Priority Data
Mar. 30, 2007 (GB) 0706144.3

(51) Int. Cl. F27B 9/30; F26B 25/06; F26B 23/02; F27B 9/10

(52) U.S. Cl. 432/8; 34/218; 432/121; 432/128; 432/201; 432/207; 432/2

(57) ABSTRACT

A curing oven, particularly for curing a continuous mat of mineral wool fibres mixed with binder has an air injecting system for injecting ambient air into at least one heating zone in circumstances in which there is a risk of inadequate ventilation.

This invention relates to a curing oven, particularly for curing a fibre mat conveyed through the oven in a continuous process.

In the production of a continuous mat formed from fibres of glasswool, rockwool or mineral wool (herein referred to as “fibre mat”), the fibres or a veil of the fibres are sprayed with a binder solution and formed so as to provide a continuous binder-impregnated fibre mat, before being fed into a curing oven. The uncured mat passing from the forming stage into the oven comprises the fibres, a water fraction (for example 2%-4% by weight) and a binder (up to about 25%, for example 4%-7% by weight).

The uncured fibre mat is continuously transported through the curing oven between upper and lower belts of a driven conveyor, which are directly heated and have perforated slats to allow passage of hot air. The distance between the two belts is set or adjustable to the desired thickness of the mat product.

The oven typically comprises several (e.g. 3 to 8) sequential heating zones through which the fibre mat is conveyed. In the heating zones, the fibre mat is heated by blowing or drawing heated air through the fibre mat. As the fibre mat progresses through the heating zones, initially the water in the mat evaporates, in the first zone(s). Then, as the mat is heated to or above the thermal-set or curing temperature (e.g. above 190° C.) and maintained at this temperature for a short time (e.g. 15 seconds), the binder in the fibre mat cures (polymerises) to produce the cured product. Curing affords the product with the necessary mechanical stability.

Adjacent heating zones within the oven are separated from each other by a wall having a slot or other aperture through which the upper and lower conveyor belts, with the fibre mat retained between them, can pass. Each heating zone has a combustion chamber with a fuel burner (oil, or gas such as natural gas or propane), a combustion fan arranged to blow ambient air into the combustion chamber and then into the heating zone, and at least one circulation fan arranged to direct heated air through the fibre mat and circulate the air via the combustion chamber to the zone. The circulation fan(s) may be disposed outside the heating zone, within closed ducting that communicates with the combustion chamber and heating zone; in this case, the combustion fan is generally disposed outside the heating zone, within appropriate ducting leading into the combustion chamber.

Ambient air enters the oven with the conveyor and through the oven seals at the top and bottom of the heating zones via the airlock vestibules, as well as within the open volume of the material and along the sides of the conveyed material. In addition, air is supplied to the oven via the combustion fans.

The heated air within the heating zone is blown onto one of the sides of, and through, the conveyed fibre mat in order to heat the slatted conveyor, the binder and fibre, and is then circulated within the zone by the circulation fan(s). This also prevents any dead zones and cold spots and thus minimises build-up of binder deposits on the oven walls. Circulation also recycles hot air to and, in some cases, around the combustion chambers for further heat input before passing the heated air once more through the conveyed fibre mat to heat and cure the binder. Air exchange to and between the oven zones is largely driven by the circulation fans.

Volatile vapours and other flammable gases generated by the curing reaction circulate within the heating zones and must be continuously ventilated from the oven in order to prevent escape to the environment, to reduce build-up of deposits within the oven and, most importantly, to prevent dangerous levels of combustible vapour from building up within the oven. In particular, the concentration of combustible gases in any part of the oven must not exceed 25% of the lower explosive limit (LEL), in order to comply with safety standards. To this end, a minimum volumetric flow of gas is to be maintained through the oven. This is significantly provided by the circulation fan(s). Exhaust air, which passes into airlock vestibules at the upper part of the entrance end (first zone) and upper part of the exit end (last zone) of the oven, is extracted by an extraction fan(s), for scrubbing or further treatment. Ambient air enters the heating zones via the combustion fans and by exchange of air from the vestibules, at the lower part of the entrance end and lower part of the exit end of the oven. Thus, adequate ventilation is ensured through the oven under normal operation.

After curing, the cured fibre mat is cooled by passing through one or more cooling zones in which ambient air is blown or drawn through the product to cool it to the required temperature. The cooled product may then be further processed as required, for example by cutting and trimming to strips of the desired length and width, optionally covering or encapsulating with facing materials, and rolling up and packaging.

In the event of an emergency stop or other interruption in the conveyor transport of the fibre mat, the in-feed of combustion gas (e.g. natural gas) to the combustion burners and of binder onto the fibre mat is automatically terminated. However, the binder in the fibre mat within the heating zones continues to cure and release volatile vapours, thereby increasing the risk that the concentration of vapours in any of the heating zones could reach explosive levels.

Furthermore, in the event of a power failure, the circulation fan(s) and exhaust fan(s) connected to the main power supply would run down, whereby gas concentrations in the oven may also increase to dangerous, potentially explosive, levels. Even without a power failure, if the circulation and/or exhaust fan were to fail for other reasons, such as due to a mechanical breakdown, ventilation in the oven may be reduced and lead to a dangerous build up of vapour concentrations.

In principle, the heating zones in the oven could be afforded with explosion panels as a safety measure, in order to contain any explosions due to vapour build-up. However, in practice, it is very difficult to install adequate explosion panels or to vent them to a safe place and consequently an explosion could cause damage and present a safety hazard.

An alternative measure would be to provide large ventilation hatches or doors which could be opened in the event that vapour build up is detected, in order to provide additional ventilation and prevent build-up of flammable concentration.

It would not be practical to provide an uninterruptible power supply (UPS) to all of the fans that ensure adequate ventilation or to provide back-up fans and isolation dampering.

According to one of its aspects, the present invention solves the problem of ensuring that explosion conditions do not arise, for example if there is inadequate ventilation in the oven, if there is a failure of the main power supply or if there is a failure of the exhaust fan and/or circulation fans.

Moreover, an advantage of present invention is that it provides a solution that can easily be retro-fitted to existing ovens of this type.

This has been achieved by the provision of an injection fan or fans for heating zones of the oven, preferably each connected to a UPS. The UPS may comprise batteries and/or a generator.

Accordingly, the present invention provides a curing oven as defined in claim 1.

The invention may also provide for advantageous operation and/or purging of a curing oven, as defined in the independent method claims.

The air injecting system preferably includes one or more injection fans. Each injection fan is preferably connected to a UPS. During normal operation of the oven, the injection fans may be in operation but dampered off by a damper such that they do not inject ambient air into the oven; this may be achieved by deadheading the fans.

The damper may be controlled so as to provide for passage of air from the air injecting system into the oven in circumstances in which there is a risk of inadequate ventilation.

Accordingly, in circumstances in which there is a risk of inadequate ventilation, for example, if the main power supply fails or if the exhaust fan fails, the injection fans inject ambient air into the heating zones and thus force exhaust gases out of the oven. This together with air input from the combustion fans will thus ensure a sufficient volumetric flow or air through the oven so as to maintain exhaust gas concentrations within safety limits.

If used to provide ventilation, each combustion fan should also be connected to a UPS. In this embodiment, in the event of main power supply failure (or ventilation failure), ambient air will be injected into the oven by the injection fans and air will also continue to be injected by the combustion fans. The combined air input from the combustion and injection fans will thus ensure a sufficient volumetric flow or air through the oven so as to maintain exhaust gas concentrations within safety limits.

Preferably, the injection fans are positioned and ducted to their respective heating zones such that they can blow ambient air onto the opposite face of the fibre mat from that onto which air from the combustion fans is blown. Thus, the injection fan and the combustion fan blow air onto opposite faces of the fibre mat when the dampering means for the injection fans have been deactivated. By blowing air onto both faces of the fibre mat, cooling of the fibre mat and localised removal of exhaust fumes is maximised.

In some oven configurations, each heating zone has a combustion burner, a combustion fan, and at least one circulation fan (preferably two circulation fans); the fans may be located externally to the heating zone and connected to the heating zone through associated ducting.

It may be particularly advantageous according to the present invention that the air injected into the heating zones is ambient air as:
Ambient air which is substantially free of flammable gasses will be immediately injected into the heating zone (as opposed air taken from another part of the oven which may contain flammable gasses) and/or
The ambient air injected may provide cooling directly into the oven heating zone and reduce the risk that the binder may undergo exothermic heating and degradation

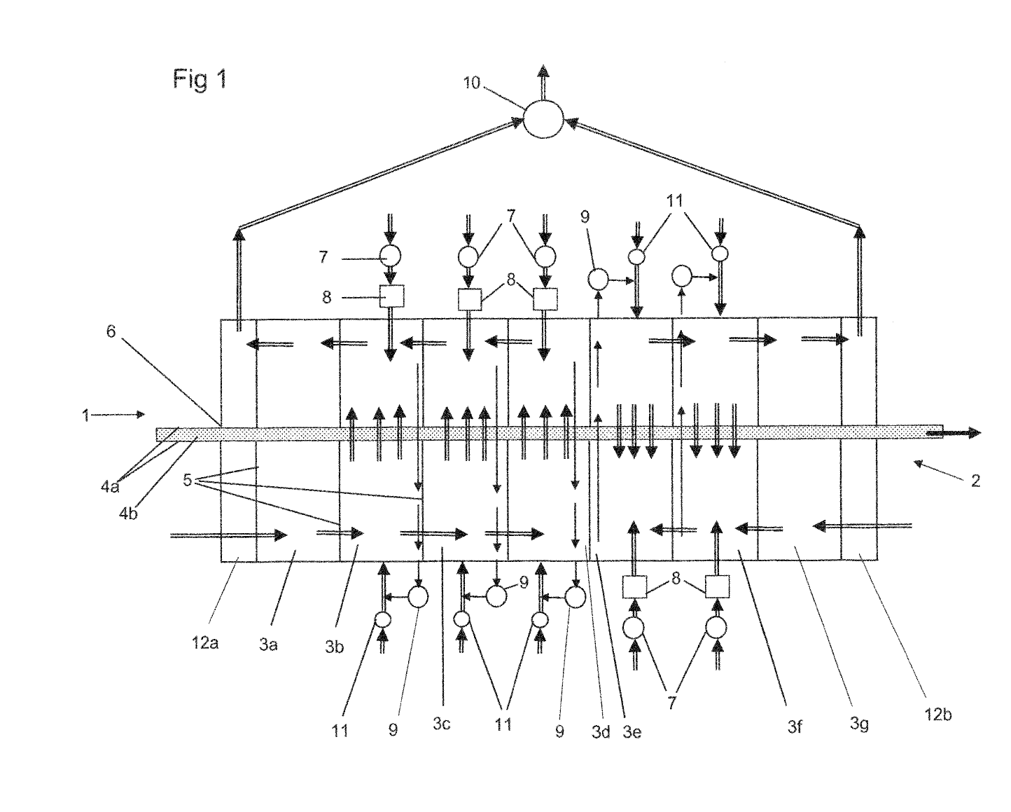

An embodiment of the curing oven showing schematically a preferred arrangement of the injection fans in relation to the combustion fans, circulation fans, exhaust fan and conveyed fibre mat is shown in FIG. 1. The oven has an entrance end (1), an exit end (2), heating zones (3a-3g) between the entrance and exit ends, a conveyor (4a) for the fibre mat (4b) which can pass through apertures (6) in the walls (5) that separate the adjacent heating zones. Exhaust gasses escaping from the top of the oven flow into airlock vestibules (12a, 12b) at the entrance and exit ends of the oven, before being extracted by exhaust fan (10). Ambient air enters the oven via the airlock vestibules.

In each zone, air is supplied to the burners in combustion chambers (not shown) by combustion fans (11). Recirculation fans (9) assist in directing the flow of heated air through the conveyed fibre mat, whilst recycling the hot gasses back to the combustion chambers. The gas flow in the initial heat zones (3a, 3b, 3c, 3d) is upwards, and in the end heat zones (3e, 3f, 3g) is downwards, onto one side of, and through, the fibre mat.

Injection fans (7) are arranged as part of an injection system to be able to inject ambient or cool air into the heating zones, and are so arranged as to blow air onto the opposite side of the fibre mat from the combustion air. Under normal operation, the injection fans are operating, but are dampered off from blowing air into the heating zones, by dampers (8).

In the event that a loss of adequate ventilation in the oven is detected, the dampers (8) are arranged to allow the injection fans (7) to blow air into the heating zones in order to produce a sufficient air flow and ventilation in the heating zones, particularly if or when combined with the combustion air. This can also protect the combustion fans from a reverse flow of hot gases.

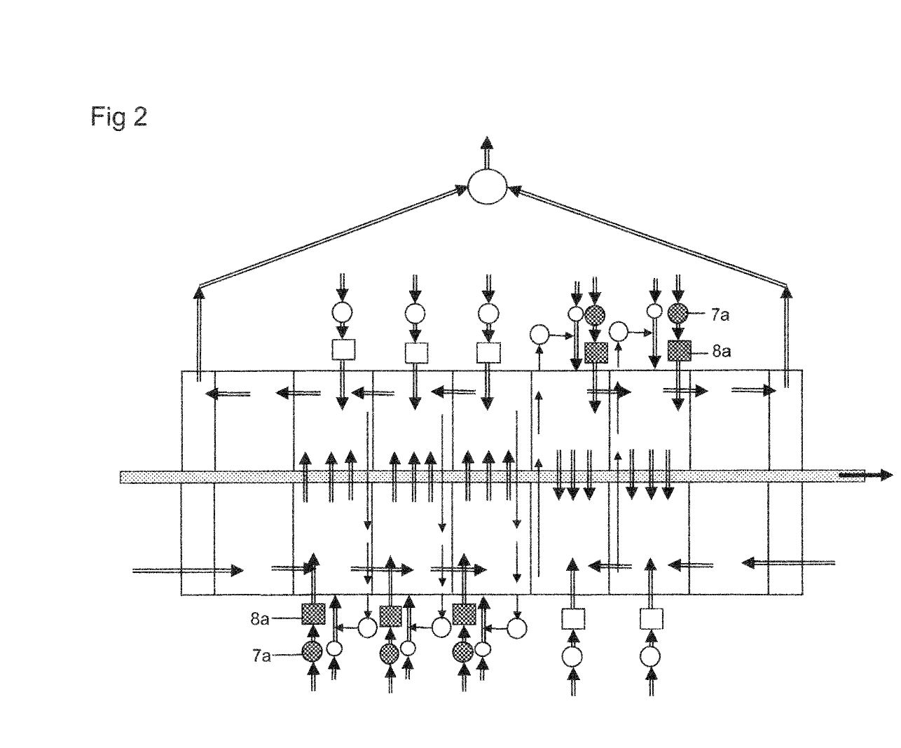

A further embodiment of the curing oven is shown schematically in FIG. 2. In this embodiment, the oven as shown in FIG. 1 is provided with a second injection fan (7a) and damper (8a) in each of the heating zones. These additional injection fans (7a) are so arranged as to blow air onto the same side of the fibre mat as the combustion fans and recirculation fans. Therefore, in this embodiment, injection fans will blow air onto both sides of the fibre mat in the event that a loss of adequate ventilation in the oven is detected.

The invention is particularly applicable for curing ovens for which the heat source is a liquid fuel or gas burner, particularly with a burner for each heating zone, for example arranged in a combustion chamber with a combustion fan to inject ambient air into and around the combustion chamber prior to passage into the oven. The invention may be applicable to other types of curing ovens, for example with electric heating elements as heat sources.

Whilst the invention has been described with particular reference to a curing oven for glass or mineral wool products, it may be applicable to other type of oven, for example in which flammable products are released within the confines of the oven.

What is claimed is:

1. A curing oven for curing a continuous mat of mineral wool fibres mixed with binder to form a continuous cured mineral fibre mat, wherein the curing oven comprises:
an entrance end;
an exit end;
at least one heating zone between the entrance end and the exit end;
a conveyor for conveying a continuous fibre mat from the entrance end through the heating zones to the exit end;
characterised in that the oven further comprises:
an air injecting system for injecting ambient air into at least one heating zone in circumstances in which there is a risk of inadequate ventilation.

2. A curing oven according to claim 1, in which the air injecting system comprises at least one fan arranged to inject ambient air into said at least one heating zone and a power supply for said at least one injection fan.

3. A curing oven according to claim 2, in which the power supply for said at least one injection fan is a secure power supply, preferably an uninterruptible power supply (UPS).

4. A curing oven according to claim 2, in which the at least one injection fan is adapted to run continuously during normal operation of the oven and the air injecting system further comprises a damper, the damper being adapted to (i) damper off said at least one injection fan during normal operation of the oven and (ii) permit injection of air into the heating zone in circumstances in which there is a risk of inadequate ventilation.

5. A curing oven according to claim 2, in which the air injecting system is adapted to activate said at least one injection fan, for example by switching on power, in circumstances in which there is a risk of inadequate ventilation.

6. A curing oven according to claim 1, in which the air injecting system comprises a source of compressed air arranged to be injected into said at least one heating zone in circumstances in which there is a risk of inadequate ventilation.

7. A curing oven according to claim 1, wherein the circumstances in which there is a risk of inadequate ventilation comprise a failure of one or more of: the main power supply, at least one exhaust fan, at least one circulation fan in at least one heating zone, at least one combustion air fan, at least one circulation fan in at least one heating zone.

8. A method of operating a curing oven comprising arranging for ambient air to be injected into at least one heating zone in circumstances in which there is a risk of inadequate ventilation.

9. A method of purging a curing oven prior to start up comprising the step of injecting ambient air into the heating zones to substantially flush out the air previously contained within the oven.

10. A method in accordance with claim 8 effected using the air injecting system of an oven in accordance with claim 1.

11. A method in accordance with claim 9 effected using the air injecting system of an oven in accordance with claim 1.
